(19) United States
(12) Patent Application Publication
(10) Pub. No.: US 2024/0217651 A1
(43) Pub. Date: Jul. 4, 2024

(54) VERTICAL TAKEOFF AIRCRAFT

(71) Applicant: Wingcopter GmbH, Weiterstadt (DE)

(72) Inventor: Jonathan HESSELBARTH, Darmstadt (DE)

(73) Assignee: Wingcopter GmbH, Weiterstadt (DE)

(21) Appl. No.: 18/557,124

(22) PCT Filed: Apr. 26, 2022
(86) PCT No.: PCT/EP2022/061078

§ 371 Date: Jan. 25, 2024

(30) Foreign Application Priority Data
Apr. 26, 2021 (DE) 10 2021 110 634.6

(51) Int. Cl. B64C 27/26; B64C 27/52

(52) U.S. Cl. CPC B64C 27/26; B64C 27/52

(57) ABSTRACT

A vertical take-off aircraft (1) has two wings arranged on an aircraft fuselage (2) of the aircraft (1). Along each wing (3), in each case at least one pivoting drive unit (5) is arranged pivotably on the wings. The at least one pivoting drive unit (5) can be brought into a vertical flying position and into a horizontal flying position. In the vertical flying position, the pivoting drive units (5) generate an uplift necessary for a vertical flying movement of the aircraft (1) and, in the horizontal flying position, a propulsion necessary for a horizontal flying movement of the aircraft (1). On each wing (3), at least one vertical drive unit (6) is arranged rigidly in a vertical flying position.

### CROSS-REFERENCE TO RELATED APPLICATION

This application is a national stage application, filed under 35 U.S.C. § 371, of International Patent Application PCT/EP2022/061078, filed on Apr. 26, 2022, which claims the benefit of German Patent Application DE 10 2021 110 634.6, filed on Apr. 26, 2021.

### BACKGROUND

Vertical take-off aircraft are used, among other things, as drones and in the military sector. These aircraft usually have two wings arranged on opposite sides of an aircraft fuselage, wherein two drive units are pivotally mounted on each of the wings in support elements, such as nacelles, which are adapted to the respective purpose and rigidly connected to the wings. Aircraft are also known in which no separate fuselage is formed and the wing is formed from two wing halves symmetrically configured along the longitudinal axis, wherein two drive units are pivotably mounted on each of the wing halves in support elements adapted to the respective purpose and rigidly connected to the wing halves.

In particular with multicopters, to control the yaw and roll angle to achieve the desired yaw and roll of the multicopter, suitable control of the drive units, which cannot be pivoted in multicopters, is achieved. The power provided by the respective drive units is specified individually for each drive in order to generate the yawing and rolling via the lift differences and torque differences generated in this way. The roll, pitch and yaw angles usually describe an orientation of the aircraft in three-dimensional space. Here, the different angles describe angles of rotation of the aircraft, starting from a zero position, which may for example correspond to the orientation of the aircraft standing on the ground, about a longitudinal, transverse and vertical axis of the aircraft. In this context, a roll axis of an aircraft is usually to be equated with the longitudinal axis of the aircraft, wherein rolling or tilting of the aircraft by a roll angle about this roll axis occurs. A pitch axis of the aircraft is a transverse axis oriented perpendicular to the roll axis, wherein pitching of the aircraft occurs through a pitch angle about this pitch axis. A yaw axis of the aircraft is designated a vertical axis oriented perpendicular to the roll axis and to the yaw axis, wherein a yaw or a roll of the aircraft through a yaw angle occurs about this yaw axis.

In addition, prior art vertical take-off aircraft are known in which the drive units are pivotally mounted directly on the wings, for example on a support structure running inside the wing. The drive units are each brought into a vertical flying position and into the horizontal flying position with a separate pivoting drive. Such a vertical take-off aircraft is described in WO 2014/016226 A1. In this vertical take-off aircraft it is provided that in the horizontal flying position the first drive unit is arranged above a wing surface and the second drive unit is arranged below the wing surface on the wing, and that in the vertical flying position the first drive unit and the second drive unit are arranged in an approximately horizontal plane. In this way, a uniform ground effect of the first and second drive unit is achieved in the vertical flight phase close to the ground, such that a smoother flight behavior is achieved in particular in the take-off and landing phase. In the horizontal flying position, the first drive unit and the second drive unit do not flow against each other, so that no loss of efficiency occurs. The fact that all drive units can be swiveled into a vertical flying position and into a horizontal flying position enables particularly precise control of the vertical flying phase. A disadvantage, however, is the large total weight of the vertical take-off aircraft, which arises due to the pivoting drives installed separately for each drive unit. In addition, the connection area between the wings and the fuselage of the aircraft must be configured to be particularly stable and load-bearing due to the large weight of the drive units or pivoting drives arranged on the wings, which increases the overall weight of the aircraft.

In particular for a vertical flight movement of the aircraft, a large drive power of the drive units is necessary during a vertical take-off of the aircraft. A large total weight of the aircraft limits the remaining flight time or distance available, which is limited by the available battery capacity.

### SUMMARY

The disclosure relates to a vertical take-off aircraft having two wings arranged on an aircraft fuselage of the aircraft. Along each wing, in each case at least one pivoting drive unit is arranged pivotably on the wings and can be brought into a vertical flying position and into a horizontal flying position. In the vertical flying position, the pivoting drive units generate an uplift necessary for a vertical flying movement of the aircraft and, in the horizontal flying position, a propulsion necessary for a horizontal flying movement of the aircraft.

It is an object of the disclosure to provide a light vertical take-off aircraft.

This object is achieved in that at least one vertical drive unit is rigidly arranged in a vertical flying position on each wing. During the horizontal flight movement, the pivoting drive units are pivoted in or against the direction of the horizontal flight movement, such that the pivoting drive units generate the drive necessary for the horizontal flight movement. The vertical drive units, which are rigidly attached to the wings and oriented in a vertical flying position, generate the lift necessary for vertical flight only during the vertical flight phase. During the horizontal direction of flight, these are flowed against laterally, creating a greater flow resistance compared to the pivoting drive units pivoted in or against the horizontal direction of flight. The fact that the vertical drive units do not have a pivoting drive means that the vertical drive unit can be configured with a particularly low weight. This also means that the weight force acting on a wing is particularly low, so that the wing as a whole, and in particular in the connection area between the wing and the aircraft fuselage, can be configured to be particularly light. All in all, a particularly weight-reduced aircraft can thus be produced, whereby a low drive power is required during the vertical flight phase when the aircraft is launched vertically.

In order to improve lateral maneuverability and yaw behavior of the aircraft in the vertical flying position, in an advantageous implementation, it is provided that at least one pivoting drive unit and at least one vertical drive unit are aligned in such a way that an angle of attack is formed between a direction of the lift force generated by the pivoting drive unit and by the vertical drive unit respectively and an axis perpendicular to a plane spanned by a roll axis of the aircraft and by a pitch axis of the aircraft. By changing the drive power of individual pivoting drive units or vertical drive units set at an angle of attack, lateral thrust can be generated, resulting in yaw about the yaw axis or roll about the roll axis of the aircraft. Advantageously, the rigidly arranged vertical drive units can be aligned in such a way that the lift forces generated by opposing vertical drive units cancel each other out as long as the respective drive powers are equal. Yawing or rolling is caused either by adjusting the respective drive power and/or by pivoting at least one pivoting drive unit. The angle of attack of the pivoting drive unit and the vertical drive unit can be selected such that a horizontal force component of the lift force is directed in the direction of the aircraft or in an opposite direction of the aircraft, in the direction of flight or in the opposite direction of flight.

In order to further improve the flight behavior of the vertically launching aircraft, in an advantageous implementation, it is provided that a first distance from the at least one pivoting drive unit to a longitudinal axis of the aircraft is smaller than a second distance from the at least one vertical drive unit to the longitudinal axis of the aircraft. By selecting a small distance between the pivoting drive units and the longitudinal axis of the aircraft, a bending moment generated by the weight force of the pivoting drive units in the connection area between the wing and the fuselage is particularly low. Thus, the wing and in particular the attachment area can be configured to be particularly small and thus weight-saving, whereby a particularly light aircraft can also be produced. Expediently, the pivoting drive units are arranged as close as possible to the longitudinal axis of the aircraft or to the aircraft fuselage. A smallest possible distance is, for example, by a rotor diameter of a rotor of the pivoting drive unit. Furthermore, placing the pivoting drive units close to the fuselage makes the wing structure stiffer overall, such that less bending vibration occurs in the wings. In particular, this improves maneuverability in the vertical flying position and results in smoother flight behavior.

By arranging the pivoting drive units at a small distance from the longitudinal axis of the aircraft, a small change in a yaw moment directed about the yaw axis of the aircraft is generated in the horizontal flying position of the pivoting drive unit when a drive power of a pivoting drive unit is changed. Advantageously, a yaw moment change can be compensated by presetting the drive power of a pivoting drive unit arranged on the opposite wing.

Advantageously, the pivoting drive units and the vertical drive units are configured in such a way that, in the event of a failure of a pivoting drive unit or a vertical drive unit, the lift necessary for the vertical flight movement or the propulsion necessary for the horizontal flight movement is compensated for by the available drive power of the functioning pivoting drive units and vertical drive units.

In order to enable continued flight of the aircraft in the event of a failure of a pivoting drive unit or a vertical drive unit, an advantageous embodiment provides that two pivoting drive units and two vertical drive units are arranged on the wing, wherein the two pivoting drive units and the two vertical drive units are each arranged one behind the other in a horizontal direction of flight of the aircraft and are arranged approximately at an equal distance from a longitudinal axis of the aircraft. Because the two pivoting drive units and two vertical drive units are arranged one behind the other in the horizontal direction of flight, the pivoting drive units and the vertical drive units can be controlled particularly easily, analogous to the control of a multicopter.

In an advantageous embodiment of the vertical take-off aircraft, it is provided that the pivoting drive units and the vertical drive units each have a supporting arm with which the pivoting drive units and the vertical drive units are fixed to the wing. Thus, a distance between the pivoting drive units and the vertical drive units can be selected independently of the wing width and length. This allows the distances between the pivoting drive units and the vertical drive units to be as large as possible, so that the lift forces generated by a change in the pivoting drive units and the vertical drive units contribute in a particularly large proportion to a control of a yaw or roll movement and for a rotation of the aircraft about a yaw, roll or pitch axis. This enables particularly stable flight behavior during the vertical flight phase.

In an advantageous embodiment, it is provided that two pivoting drive units arranged one behind the other in the horizontal direction of flight are arranged in a horizontal flying position respectively above and below a horizontal plane, wherein the horizontal plane is arranged parallel to a plane spanned by the roll axis of the aircraft and by the pitch axis of the aircraft. In the horizontal flying position, the pivoting drive units arranged one behind the other in the horizontal direction of flight do not flow against each other, such that no loss of efficiency occurs as a result. The horizontal plane can also coincide with the plane spanned by the roll axis of the aircraft and the pitch axis of the aircraft.

In an advantageous implementation, it is provided that two pivoting drive units arranged one behind the other in the horizontal direction of flight are arranged in a vertical flying position within the horizontal plane. In this way, a uniform ground effect of the pivoting drive units oriented in the vertical flying position is achieved in the vertical flying phase near the ground, such that a smoother flight behavior is achieved in particular in the take-off and landing phase of the aircraft. However, minor deviations from such an arrangement, which can be attributed to manufacturing tolerances, for example, do not affect the flight behavior of the aircraft, or only affect it slightly.

In an advantageous implementation, it is provided that a vertical distance between the pivoting drive unit and a wing plane spanned by the wing can be predetermined by an angle of attack enclosed between a longitudinal axis of the supporting arm and the wing plane. In this case, the angle of attack can be predetermined in such a way that the pivoting drive units are arranged essentially in the horizontal plane in the vertical flying position and are arranged above and below the horizontal surface in a horizontal flying position. Expediently, the supporting arms are arranged on the wing in such a way that a first pivoting drive unit is located in front of the wing in the horizontal direction of flight in the vertical flying position and a second pivoting drive unit is located behind the wing. In this case, the supporting arms can be configured and arranged on the wing in such a way that the pivoting drive units, which are arranged one behind the other in the horizontal direction of flight, are arranged essentially below and above the wing in the horizontal flying position. Due to the arrangement of the pivoting drive units in the horizontal direction of flight in front of and behind the wing, the wing can be extended and thus additional wing extension can be generated. This reduces induced drag on the wings in horizontal flight and improves flight performance.

In order to achieve a particularly stable flight behavior close to the ground during the take-off and landing phase of the aircraft, in an advantageous embodiment it is provided that the vertical drive units arranged one behind the other in the horizontal direction of flight are arranged within the horizontal plane. In this way, a uniform ground effect of the vertical drive units oriented in the vertical flying position is achieved in the vertical flight phase close to the ground.

In order to achieve a particularly stable flight behavior of the aircraft in the vertical flight phase, it is provided in an advantageous embodiment that the pivoting drive units each have a pivoting device, such that a pivoting movement of the pivoting drive units can be carried out independently of one another. The redundancy of multiple pivoting drive units allows the maneuverability of the aircraft to be maintained even in the event of a failure of one pivoting drive unit, allowing the aircraft to continue flying.

A particularly cost-effective construction and particularly good flight behavior is achieved by the pivoting drive units and the vertical drive units being propeller drives or impeller drives or jet engines. Propeller drives are expediently configured rigidly or with a rotor blade adjustment.

Further advantages and embodiments of the vertical take-off aircraft are explained in more detail with reference to the exemplary embodiments shown in the drawing.

### BRIEF DESCRIPTION OF THE DRAWINGS

FIG. 1 shows a schematic representation of a vertical take-off aircraft in the horizontal direction of flight,

FIG. 2 shows a schematic representation of a vertical take-off aircraft in the vertical direction of flight,

FIG. 3 shows a schematic representation of a vertical take-off aircraft in a front view in the horizontal direction of flight.

### DETAILED DESCRIPTION

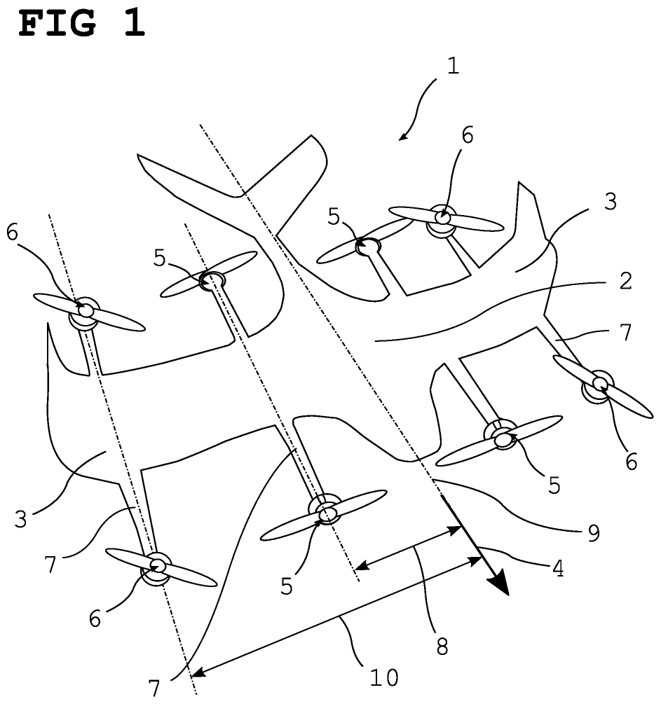

FIG. 1 shows a schematic representation of a vertical take-off aircraft 1 in a horizontal direction of flight. The aircraft 1 comprises two wings 3 arranged on an aircraft fuselage 2 of the aircraft 1. Two pivoting drive units 5 arranged one behind the other in a horizontal direction of flight 4 and two vertical drive units 6 arranged one behind the other in the horizontal direction of flight 4 are arranged on each wing 3. The pivoting drive units 5 and the vertical drive units 6 each have a supporting arm 7 with which the pivoting drive units 5 and the vertical drive units 6 are secured to the wing 3. The pivoting drive units 5 can be brought into a vertical flying position and into a horizontal flying position. The vertical drive unit 6 are rigidly arranged in a vertical flying position. During a horizontal flight movement the pivoting drive units 5 are pivoted in or against the horizontal direction of flight 4, such that the pivoting drive units 5 generate the drive necessary for the horizontal flight movement. The vertical drive units 6, which are rigidly attached to the wings 3 and oriented in a vertical flying position, generate the lift necessary for vertical flight only in the vertical flight phase. A first distance 8 of the two pivoting drive units 5 arranged one behind the other in the horizontal direction of flight 4 from a longitudinal axis 9 of the aircraft 1 is smaller than a second distance 10 of the two vertical drive units 6 arranged one behind the other in the horizontal direction of flight 4 from the longitudinal axis 9 of the aircraft 1.

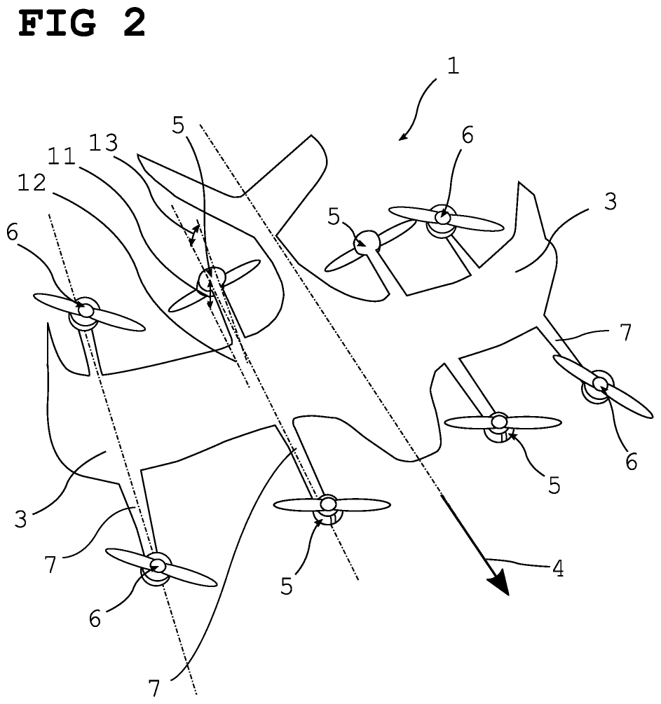

FIG. 2 shows a schematic representation of the vertical take-off aircraft 1 in a vertical direction of flight. The pivoting drive units 5 and the vertical drive units 6 each have a supporting arm 7 with which the pivoting drive units 5 and the vertical drive units 6 are secured to the wing 3.

A vertical distance 11 between the pivoting drive unit 6 and a wing plane 12 spanned by the wing 3 can be predetermined by an angle of attack 13 enclosed between a longitudinal axis of the supporting arm 7 and the wing plane 12. The pivoting drive units 5 are shown in a vertical flying position. The vertical drive unit 6 are rigidly arranged in a vertical flying position. During a vertical flying movement, the pivoting drive units 5 are pivoted into the vertical flying position, such that the pivoting drive units 5 rigidly arranged on the wings 3 and the vertical drive units 6 generate the lift necessary for the vertical flying movement.

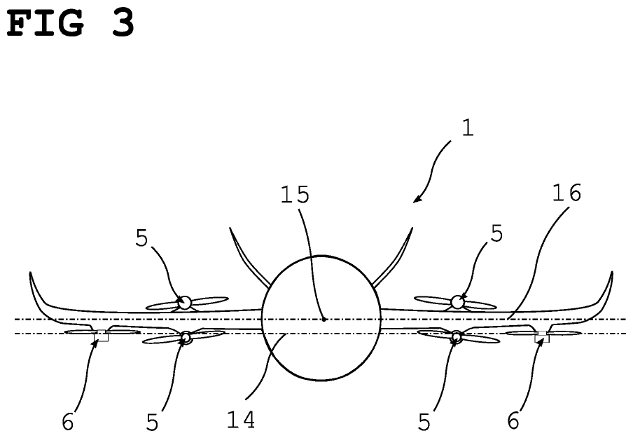

FIG. 3 shows a schematic representation of the vertical take-off aircraft 1 in a front view in horizontal flight. The two pivoting drive units 5 (not shown in FIG. 3) arranged one behind the other in the horizontal direction of flight 4 are arranged in a horizontal flying position respectively above and below a horizontal plane 14, wherein the horizontal plane 14 is arranged parallel to a plane spanned by a roll axis 15 of the aircraft 1 and by a pitch axis 16 of the aircraft 1. Thus, the pivoting drive units 5 arranged one behind the other in the horizontal flying position in the horizontal direction of flight 4 do not flow against each other.

1.-11. (canceled)

12. A vertical take-off aircraft (1), comprising:
an aircraft fuselage (2);
two wings arranged on the aircraft fuselage (2);
at least one pivoting drive unit (5) pivotably arranged on each wing (3) of the two wings; and
at least one vertical drive unit (6) rigidly arranged in a vertical flying position on each wing (3),
wherein each at least one pivoting drive unit (5) can be brought into a vertical flying position and into a horizontal flying position, and
wherein, in the vertical flying position, the pivoting drive units (5) generate an uplift necessary for a vertical flying movement of the vertical take-off aircraft (1) and, in the horizontal flying position, a propulsion necessary for a horizontal flying movement of the vertical take-off aircraft (1).

13. The vertical take-off aircraft (1) according to claim 12,
wherein the at least one pivoting drive unit (5) and the at least one vertical drive unit (6) are aligned in such a way that an angle of attack is formed between
a direction of a lift force generated by the pivoting drive unit (5) and by the vertical drive unit (6) respectively and
an axis perpendicular to a plane spanned by a roll axis (15) of the aircraft (1) and by a pitch axis (16) of the aircraft (1).

14. The vertical take-off aircraft (1) according to claim 12,
wherein a first distance (8) from the at least one pivoting drive unit (5) to a longitudinal axis (9) of the aircraft (1) is smaller than a second distance (10) from the at least one vertical drive unit (6) to the longitudinal axis (9) of the aircraft (1).

15. The vertical take-off aircraft (1) according to claim 12,
wherein two pivoting drive units (5) and two vertical drive units (6) are arranged on each wing (3),
wherein the two pivoting drive units (5) and the two vertical drive units (6) are each arranged one behind the other in a horizontal direction of flight (4) of the aircraft (1) and are arranged approximately at an equal distance from a longitudinal axis (9) of the aircraft (1).

16. The vertical take-off aircraft (1) according to claim 12,
wherein the pivoting drive units (5) and the vertical drive units (6) each have a supporting arm (7) with which the pivoting drive units (5) and the vertical drive units (6) are secured to each wing (3).

17. The vertical take-off aircraft (1) according to claim 12,
wherein two pivoting drive units (5) arranged one behind the other in the horizontal direction of flight (4) are arranged in a horizontal flying position respectively above and below a horizontal plane (14),
wherein the horizontal plane (14) is arranged parallel to a plane spanned by a roll axis (15) of the aircraft (1) and by a pitch axis (16) of the aircraft (1).

18. The vertical take-off aircraft (1) according to claim 12,
wherein two pivoting drive units (5) arranged one behind the other in the horizontal direction of flight (4) are arranged in a vertical flying position within a horizontal plane (14).

19. The vertical take-off aircraft (1) according to claim 16,
wherein a vertical distance (11) between the pivoting drive unit (5) and a wing plane (12) spanned by the wing (3) can be predetermined by an angle of attack (13) enclosed between a longitudinal axis (9) of the supporting arm (7) and the wing plane (12).

20. The vertical take-off aircraft (1) according to claim 15,
wherein the vertical drive units (6) arranged one behind the other in the horizontal direction of flight (4) are arranged within a horizontal plane (14).

21. The vertical take-off aircraft (1) according to claim 12,
wherein pivoting drive units (5) each have a pivoting device, such that a pivoting movement of the pivoting drive units (5) can be carried out independently of one another.

22. The vertical take-off aircraft (1) according to claim 12,
wherein the pivoting drive units (5) and the vertical drive units (6) are propeller drives or impeller drives or jet engines.
